(19) United States
(12) Patent Application Publication
(10) Pub. No.: US 2022/0036516 A1
(43) Pub. Date: Feb. 3, 2022

(54) TRAINING METHODS OF A DENOISING MODEL AND IMAGE DENOISING METHODS AND APPARATUSES

(71) Applicant: Neusoft Medical Systems Co., Ltd., Shenyang (CN)

(72) Inventors: Mingliang CHEN, Shenyang (CN); Zhenzhuang MIAO, Shenyang (CN); Aiqi SUN, Shenyang (CN); Kehui NIE, Shenyang (CN)

(21) Appl. No.: 17/387,075

(22) Filed: Jul. 28, 2021

(30) Foreign Application Priority Data
Jul. 29, 2020 (CN) 202010746975.4

(51) Int. Cl. G06T 5/00; G06N 20/00

(52) U.S. Cl. CPC G06T 5/002; G06N 20/00; G06T 2207/20084; G06T 2207/10088; G06T 2207/20081

(57) ABSTRACT

The present disclosure relates to a training method of a denoising model, an image denoising method and device. The training method includes: obtaining a plurality of to-be-denoised sample images; for each of the to-be-denoised sample images, obtaining a priori knowledge information corresponding to noise in the to-be-denoised sample image; for each of the to-be-denoised sample images, constructing a model training sample based on the to-be-denoised sample image and the a priori knowledge information; training a denoising model based on the model training samples to obtain a target denoising model for removing noise in image.

### CROSS REFERENCE TO RELATED APPLICATION

The present application claims priority to Chinese Patent Application No. 202010746975.4, filed on Jul. 29, 2020, the disclosure of which is incorporated herein by reference in its entirety.

### TECHNICAL FIELD

The present disclosure relates to the field of image processing, and in particular to a training method of a denoising model, an image denoising method and apparatus.

### BACKGROUND

Generally, an image collected by an image acquisition device may have a low signal-to-noise ratio due to pollution of noise sources, which affects the image quality. For example, a medical image with a low signal-to-noise ratio may affect a doctor's diagnosis of a patient based on the medical image. Therefore, it is desirable to obtain a higher signal-to-noise ratio image without reducing the image resolution, affecting the image contrast, or increasing the acquisition time, so as to improve the image quality.

NEUSOFT MEDICAL SYSTEMS CO., LTD. (NMS), founded in 1998 with its world headquarters in China, is a leading supplier of medical equipment, medical IT solutions, and healthcare services. NMS supplies medical equipment with a wide portfolio, including CT, Magnetic Resonance Imaging (MRI), digital X-ray machine, ultrasound, Positron Emission Tomography (PET), Linear Accelerator (LINAC), and biochemistry analyser. Currently, NMS' products are exported to over 60 countries and regions around the globe, serving more than 5,000 renowned customers. NMS's latest successful developments, such as 128 Multi-Slice CT Scanner System, Superconducting MRI, LINAC, and PET products, have led China to become a global high-end medical equipment producer. As an integrated supplier with extensive experience in large medical equipment, NMS has been committed to the study of avoiding secondary potential harm caused by excessive X-ray irradiation to the subject during the CT scanning process.

### SUMMARY

The present disclosure relates to a training method of a denoising model, an image denoising method and related apparatus.

In a first aspect of the present disclosure, a training method of a denoising model is provided, including: obtaining a plurality of to-be-denoised sample images; for each of the to-be-denoised sample images, obtaining a priori knowledge information corresponding to noise in the to-be-denoised sample image; for each of the to-be-denoised sample images, constructing a model training sample based on the to-be-denoised sample image and the a priori knowledge information; and training a denoising model based on a plurality of model training samples to obtain a target denoising model for removing noise in an image.

In a second aspect of the present disclosure, an image denoising method is provided, including: obtaining a to-be-denoised image; obtaining a priori knowledge information corresponding to a noise in the to-be-denoised image; inputting the to-be-denoised image and the a priori knowledge information into a trained target denoising model, to obtain a denoised target image output by the target denoising model, wherein the target denoising model is trained by obtaining a plurality of to-be-denoised sample images; for each of the to-be-denoised sample images, obtaining a priori knowledge information corresponding to a noise in the to-be-denoised sample image; for each of the to-be-denoised sample images, constructing a model training sample based on the to-be-denoised sample image and the a priori knowledge information; training a denoising model based on a plurality of model training samples to obtain a target denoising model for removing noise in image.

In a third aspect of the present disclosure, a training apparatus for a denoising model is provided, including: a first obtaining module, configured to obtain a plurality of to-be-denoised sample images; a second obtaining module, configured to, for each of the to-be-denoised sample images, obtain a priori knowledge information corresponding to a noise in the to-be-denoised sample image. a constructing module, configured to, for each of the to-be-denoised sample images, construct a model training sample based on the to-be-denoised sample image and the a priori knowledge information; a training module, configured to train a denoising model based on a plurality of model training samples to obtain a target denoising model for removing noise in image.

In a fourth aspect of the present disclosure, an image denoising apparatus is provided, including: a third obtaining module, configured to obtain a to-be-denoised image; a fourth obtaining module, configured to obtain a priori knowledge information corresponding to a noise in the to-be-denoised image; a first inputting module, configured to inputting the to-be-denoised image and the a priori knowledge information into a trained target denoising model, to obtain a denoised target image output by the target denoising model, wherein the target denoising model is trained by: obtaining a plurality of to-be-denoised sample images; for each of the to-be-denoised sample images, obtaining a priori knowledge information corresponding to a noise in the to-be-denoised sample image; for each of the to-be-denoised sample images, constructing a model training sample based on the to-be-denoised sample image and the a priori knowledge information; training a denoising model based on a plurality of model training samples to obtain a target denoising model for removing noise in image.

In a fifth aspect of the present disclosure, a computer-readable storage medium storing a computer program is provided, when the program is executed by a processor, causes the processor to implement the steps of the method provided by the first aspect of the present disclosure.

In a sixth aspect of the present disclosure, a computer-readable storage medium storing a computer program is provided, when the program is executed by a processor, causes the processor to implement the steps of the method provided by the second aspect of the present disclosure.

In a seventh aspect of the present disclosure, an electronic device is provided, including: a memory storing a computer program; a processor, configured to execute the computer program in the memory to implement the steps of the method provided by the first aspect of the present disclosure.

In an eighth aspect of the present disclosure, an electronic device is provided, including: a memory storing a computer program; a processor, configured to execute the computer program in the memory to implement the steps of the method provided by the second aspect of the present disclosure.

Using the approaches described here, by training a denoising sample model based on a to-be-denoised sample image and a priori knowledge information corresponding to the noise in the to-be-denoised sample image, a target denoising model dedicated to removing the noise in the image can be obtained. In this way, each target denoising model obtained by training has a specific function, which provides good interpretability for the target denoising model. Constructing model training samples according to the to-be-denoised sample image and a priori knowledge information can improve the training efficiency of the model, which compared with only using the to-be-denoised sample image as the model training sample, effectively reduces the dependence of the model on the training samples, and improves the generalization of the model.

Other features and advantages of the present disclosure will be described in detail in the following specific embodiments.

### BRIEF DESCRIPTION OF THE DRAWINGS

The details of one or more embodiments of the subject matter described in the present disclosure are set forth in the accompanying drawings and description below. Other features, aspects, and advantages of the subject matter will become apparent from the description, the drawings, and the claims. Features of the present disclosure are illustrated by way of example and not limited in the following figures, in which like numerals indicate like elements.

FIG. 1 is a flowchart illustrating a training method of a denoising model according to an example.

FIG. 2 is a flowchart illustrating an image denoising method according to an example.

FIG. 3 is a flowchart illustrating an image denoising method according to an example.

FIG. 4 is a block diagram illustrating a training apparatus for a denoising model according to an example.

FIG. 5 is a block diagram illustrating an image denoising apparatus according to an example.

FIG. 6 is a schematic structural diagram illustrating an electronic device according to an example.

FIG. 7 is a schematic structural diagram illustrating an electronic device according to an example.

### DETAILED DESCRIPTION OF THE EMBODIMENTS

In some cases, denoising of an image usually involves denoising at a post-processing end of an image acquisition and/or processing process. For example, after an image is collected by an image acquisition device, a filtering denoising algorithm such as a denoising algorithm based on statistical characteristics or a common denoising method of deep learning is applied for denoising of the collected image.

The denoising method of deep learning often uses a black box model, focusing only on an overall function, and directly removes mixed noise in an image. In this way, specific functions realized by the model cannot be measured, resulting in low interpretability of the model. The black box model directly suppresses the blended noise end-to-end, making it unable to make full use of a priori knowledge of different noise sources, and a denoising effect of the model is limited to a training set, resulting in weak generalization of the model.

Specific examples of the present disclosure will be described in detail below in combination with accompanying drawings. It should be understood that the specific embodiments described herein are only used to illustrate and explain the present disclosure, and are not used to limit the present disclosure.

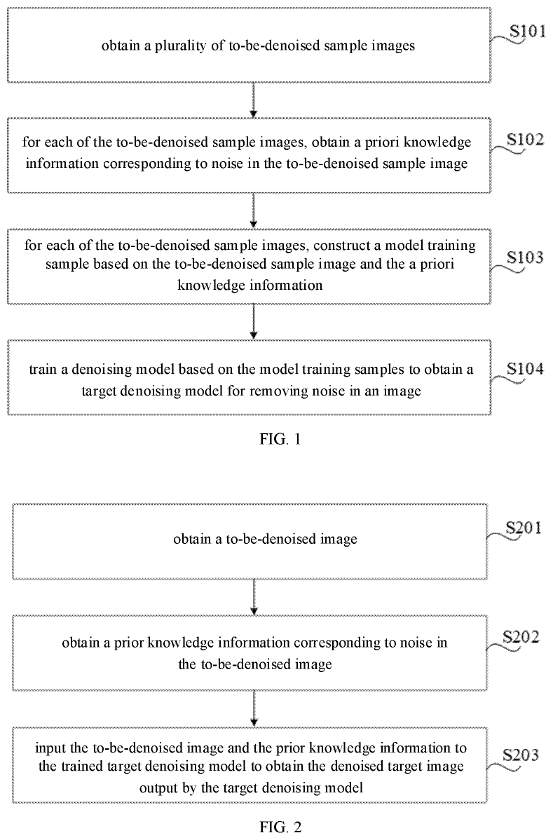

FIG. 1 is a flowchart illustrating a training method of a denoising model according to an example. As shown in FIG. 1, the method may include the following elements.

At S101, a plurality of to-be-denoised sample images are obtained.

In the present disclosure, a to-be-denoised sample image may be an image including noise. The sample image can be input by a user, or an original image can be obtained from an image acquisition device. The original sample image is input to an electronic device that executes the training method. The to-be-denoised sample image may be an image collected by any appropriate image acquisition device, for example, the sample image may be a medical image collected by a medical image acquisition device, for example, a magnetic resonance device, a CT (computer tomography) device, etc.; or a natural image collected by a camera, etc. If the to-be-denoised sample image is a medical image, a trained target denoising model in the medical field can be applied for removing noise in the medical image. If the to-be-denoised sample image is a natural image, a trained target denoising model in the field of natural scenes can be applied to remove noise in the natural image. In the present disclosure, the to-be-denoised sample image is a medical image as an example for description.

At S102, for each of the to-be-denoised sample images, a priori knowledge information corresponding to noise in the to-be-denoised sample image is obtained.

In the process of collecting medical images by the medical image acquisition device, pre-scan data is collected at the same time, and a priori knowledge information is generated based on the pre-scan data. For example, if a size of the to-be-denoised sample image is 200×200 pixels, a priori knowledge information corresponding to the noise in the to-be-denoised sample image may be an image with a size of 200×200 pixels which indicates distribution of the noise.

The a priori knowledge information can be generated with reference to related technologies, which is not limited in the present disclosure.

The obtained a priori knowledge information for a given to-be-denoised sample image corresponds to the noise in the to-be-denoised sample image. For instance, the a priori knowledge information is a priori knowledge information generated based on intermediate data collected during the process of collecting the to-be-denoised sample image by the medical image acquisition device. In other words, for different to-be-denoised sample images, even if the sources of the noise to be canceled are the same across multiple sample images, the generated a priori knowledge information may be different for each sample image.

At S103, for each of the to-be-denoised sample images, a model training sample is constructed based on the to-be-denoised sample image and the a priori knowledge information.

In general, the model training samples include multiple sets of data. Each set of data can include a to-be-denoised sample image and corresponding a priori knowledge information. Therefore, a plurality of to-be-denoised sample images and corresponding a priori knowledge information can be used to construct model training samples.

At S104, a denoising model is trained based on a plurality of model training samples to obtain a target denoising model for removing noise in an image.

After the model training samples are obtained, the model training samples are used to train the denoising sample model, and the target denoising model is obtained. The target denoising model can be used to denoise an image. The denoising sample model can be any appropriate two dimensional (2D) convolutional neural network, such as u-net, ResNet, DenseNet, etc.

Using the method described in FIG. 1, a target denoising model for removing different types of noise in the image can be trained according to actual needs. For example, assuming that the to-be-denoised sample image includes noise A, the obtained a priori knowledge information is a priori knowledge information A′ corresponding to the noise A in the to-be-denoised sample image. The target denoising model trained based on the above method is a model used to remove the noise A in the image. For another example, assuming that the to-be-denoised sample image includes noise B, the obtained a priori knowledge information is a priori knowledge information B′ corresponding to the noise B in the to-be-denoised sample image. The target denoising model trained based on the above method is a model used to remove the noise B in the image. The noise sources of the noise A and noise B are different.

Using the above technical solutions, by training the denoising sample model based on the to-be-denoised sample images and the a priori knowledge information corresponding to a type of noise in the to-be-denoised sample images, a target denoising model for removing the type of noise in the image can be obtained. In this way, each target denoising model obtained by such training has a specific function, which provides good interpretability for the target denoising model. Constructing model training samples according to the to-be-denoised sample images and the corresponding a priori knowledge information can improve the training efficiency of the model, effectively reduce the dependence of the model on the training samples, and improve the generalization of the model.

The training method of the denoising model shown in FIG. 1 can be used to train a model for removing a certain type of noise, and can also be used for training a model for sequentially removing different types of noise.

In an embodiment, each to-be-denoised sample image includes M types of noise. The denoising model includes M sub-models connected in sequence, where M is greater than or equal to 2. The input of a first sub-model in the M sub-models connected in sequence is model training samples constructed based on the to-be-denoised sample images and a priori knowledge information corresponding to a first type of noise in a denoising order for the to-be-denoised sample images. The input of an N-th sub-model is model training samples constructed based on images output by an (N−1)-th sub-model and a priori knowledge information corresponding to an N-th type of noise in the denoising order. The value of N can range from 2 to M.

As an example, suppose that the to-be-denoised sample images include three types of noise, namely noise A, noise B, and noise C, and the denoising order for the to-be-denoised sample images is noise A, noise B, and then noise C. The denoising model includes a first sub-model, a second sub-model, and a third sub-model that are sequentially connected. In the training process, model training sub-sample 1 is first constructed based on a priori knowledge information corresponding to noise A and a to-be-denoised sample image. Model training sub-sample 1 is input to the first sub-model to obtain a first sample image output by the first sub-model, where the first sample image is an image after the noise A is removed from the to-be-denoised sample image. Next, model training sub-sample 2 is constructed based on a priori knowledge information corresponding to noise B and the first sample image output by the first sub-model. Model training sub-sample 2 is input to the second sub-model to obtain a second sample image output by the second sub-model, where the second sample image is an image after the noise A and noise B are sequentially removed from the to-be-denoised sample image. Finally, model training sub-sample 3 is constructed based on a priori knowledge information corresponding to noise C and the second sample image output by the second sub-model. Model training sub-sample 3 is input to the third sub-model to obtain a third sample image output by the third sub-model, where the third sample image is an image after the noise A, noise B and noise C are sequentially removed from the to-be-denoised sample image. In this way, a sub-model for removing noise A, a sub-model for removing noise B, and a sub-model for removing noise C can be obtained after successive training.

According to the above method, the to-be-denoised sample images including different types of noises and the a priori knowledge information corresponding to each type of noise are used for sequential training. For different type of noise, a sub-model dedicated to removing a type of noise can be obtained in sequence, thereby improving the denoising accuracy of the model.

A typical image acquisition device involves noise in the process of acquiring images, for example, a magnetic resonance device and a CT device themselves have system noise. The system noise of the image acquisition device generally presents as a Gaussian distribution. Therefore, in this disclosure, the system noise of the image acquisition device can be referred to as Gaussian noise. Therefore, in an embodiment, the a priori knowledge information includes a Gaussian noise distribution map, and obtaining the a priori knowledge information corresponding to the noise in the to-be-denoised sample image may further include obtaining a Gaussian noise map corresponding to the Gaussian noise in the to-be-denoised sample image.

For example, if an obtained to-be-denoised sample image includes Gaussian noise, and the obtained a priori knowledge information is a Gaussian noise distribution map corresponding to the Gaussian noise in the to-be-denoised sample image, the model training samples constructed by the to-be-denoised sample images and the Gaussian noise distribution maps can be used to train the denoising sample model to obtain a target denoising model for removing the Gaussian noise generated by the image acquisition device.

In an embodiment, the to-be-denoised sample images may be magnetic resonance images. Magnetic resonance refers to a phenomenon in which proton spin direction distribution meets the Boltzmann distribution under the action of an external magnetic field, protons absorb energy under the action of a radio frequency magnetic field with a specific frequency, and protons relax and release energy after the radio frequency magnetic field is removed. Magnetic resonance imaging (MRI) mainly uses this principle, combined with techniques such as spatial coding and Fourier transform, and uses detected magnetic resonance signals to restore internal structure information of an imaging object.

In this context, obtaining a plurality of to-be-denoised sample images may include, for each of the to-be-denoised sample images, obtaining multi-channel sample data collected by magnetic resonance coils and performing parallel imaging on the multi-channel sample data to obtain a magnetic resonance image as the to-be-denoised sample image.

In this embodiment, the parallel imaging can include SENSE (Sensitivity Encoding) method, GRAPPA (GeneRalized Autocalibrating Partially Parallel Acquisitions) method, SPIRiT (iterative self-consistent parallel imaging reconstruction from arbitrary k-space) method, SAKE (simultaneous autocalibrating and k-space estimation) method, and so on.

Using the aforementioned parallel imaging methods may introduce folded artifacts and reduce the signal-to-noise ratio of the image. Therefore, in the magnetic resonance image obtained by performing the combining process on the multi-channel sample data with a parallel imaging manner, first noise generated during the combining process exists.

Since the multi-channel sample data is collected by the magnetic resonance coils, the reconstructed image is often uneven due to the non-uniformity of a main magnetic field, a radio frequency transmitting field, or a radio frequency receiving field. Therefore, in this embodiment, the noise in the to-be-denoised sample image may also include second noise caused by the non-uniformity of the magnetic resonance coils. Similarly, the noise in the to-be-denoised sample image may also include Gaussian noise generated by the magnetic resonance device. Therefore, in this embodiment, the noise in the to-be-denoised sample image includes at least one of the following: first noise generated during the combining process, second noise caused by non-uniformity of the magnetic resonance coils, and Gaussian noise generated by a magnetic resonance device.

In an embodiment, the noise in the to-be-denoised sample image includes the first noise. A specific implementation of constructing the model training sample based on the to-be-denoised sample image and the a priori knowledge information is as follows: constructing the model training sample based on the multi-channel sample data, the to-be-denoised sample image and a priori knowledge information corresponding to the first noise. In the case that the noise in the to-be-denoised sample image is the first noise, the a priori knowledge information corresponding to the first noise can be, for example, a noise distribution map as a G-Map (geometric factor distribution map), a QBC (quadrature body coil) map, or multi-channel low-resolution images. Since the parallel imaging manners used are different, the a priori knowledge information corresponding to the first noise is also different. The G-Map is calculated and generated according to a parallel imaging algorithm based on the multi-channel sample data and the multi-channel noise data.

In this embodiment, the model training samples used to train the target denoising model for removing the first noise in the image may include, in addition to the to-be-denoised sample image and the a priori knowledge information corresponding to the first noise, the multi-channel sample data. Since the multi-channel sample data is real data collected by the magnetic resonance coils, when removing the first noise, it can be ensured that the image obtained after denoising is an undistorted image. In this way, the first noise in the image can be removed, and the image after removing the first noise is not distorted.

In an embodiment, the noise in the to-be-denoised sample image includes the second noise. Accordingly, a priori knowledge information corresponding to the second noise may include a coil sensitivity map (CSM).

For example, a pre-scan method may be used to obtain the CSM, a same part of the to-be-denoised sample image is pre-scanned to obtain data of array coils and the quadrature body coil respectively, and an array coil map and a quadrature body coil map are obtained. Then the CSM can be obtained by dividing the array coil map by the quadrature body coil map.

In an embodiment, the noise in the to-be-denoised sample image includes Gaussian noise. Accordingly, a priori knowledge information corresponding to the Gaussian noise may include a Gaussian distribution map. A standard Gaussian noise distribution map can be generated by way of computer-generated 2D pseudo-random codes.

In an embodiment, the noise in the to-be-denoised sample image includes at least two of the first noise, the second noise and the Gaussian noise. For example, if the noise in the to-be-denoised sample image includes the above three, the target denoising model trained by using the to-be-denoised sample images includes three models, which are a first model used to remove the first noise in the image, a second model used to remove the second noise in the image, and a third model used to remove the Gaussian noise in the image.

The specific training process is as follows.

A priori knowledge information (for example, a G-Map) corresponding to the first noise is obtained, a first model training sample is constructed according to a multi-channel sample image, a to-be-denoised sample image and the G-Map, and first model training samples are used to train the denoising sample model, so as to obtain the first model.

A priori knowledge information (for example, a coil sensitivity information distribution map, CSM) corresponding to the second noise is obtained, a second model training sample is constructed based on a to-be-denoised sample image and the CSM, and second model training samples are used to train the denoising sample model, so as to obtain the second model.

A priori knowledge information (for example, a Gaussian distribution map) corresponding to the Gaussian noise is obtained, a third model training sample is constructed based on a to-be-denoised sample image and the Gaussian distribution map, and third model training samples are used to train the denoising sample model, so as to obtain the third model.

If the first model, the second model, and the third model are obtained through separate training, the to-be-denoised sample image can be the same image, e.g., a magnetic resonance image obtained by performing the combining process on the multi-channel sample data using a parallel imaging manner. If the first model, the second model, and the third model are obtained by training in sequence, the to-be-denoised image for constructing the second model training sample can be an image output by the first model, and the to-be-denoised image for constructing the third model training sample can be an image output by the second model.

According to the above method, for each type of noise, a target denoising model for removing the type of noise can be trained, so that good interpretability is provided for the target denoising model.

FIG. 2 is a flowchart illustrating an image denoising method according to an example. As shown in FIG. 2, the method may include elements S201 to S203.

At S201, a to-be-denoised image is obtained.

The to-be-denoised image may be an image including noise input by the user, or an original image obtained from an image acquisition device, where the original image is input to an electronic device that executes the denoising method, and so on. The to-be-denoised image may be an image collected by any image acquisition device, for example, it may be a medical image collected by a medical image acquisition device (such as a magnetic resonance device, a CT device, etc.), or a natural image collected by a camera, etc.

At S202, a priori knowledge information corresponding to noise in the to-be-denoised image is obtained.

For example, referring to the training method shown in FIG. 1, the a priori knowledge information corresponding to the noise in the to-be-denoised image can be obtained.

At S203, the to-be-denoised image and the a priori knowledge information are input into a trained target denoising model to obtain a denoised target image output by the target denoising model.

The target denoising model may be a target denoising model obtained by training with the training method shown in FIG. 1.

By using the above technical solutions, the noise corresponding to different noise sources can be respectively removed, and the interpretability of the denoising process can be improved. In the denoising process, a priori knowledge information corresponding to each type of noise is considered, which improves the accuracy of denoising.

In some examples, the to-be-denoised image includes M types of noise, and the denoising model includes M target sub-models connected in sequence, and M is an integer greater than or equal to 2.

The input of a first sub-target denoising model in the M sub-target denoising models connected in sequence is the to-be-denoised image and a priori knowledge information corresponding to a first type of noise in a denoising order for the to-be-denoised image, and the input of an N-th sub-target denoising model is an image output by an (N−1)-th sub-target denoising model and a priori knowledge information corresponding to an N-th type of noise in the denoising order, where a value range of N is 2 to M.

In the above manner, by using multiple sub-target denoising models connected in sequence, different types of noise in the to-be-denoised image can be sequentially removed, which improves the denoising refinement of the model.

In an embodiment, the target denoising model is a model for removing Gaussian noise, the a priori knowledge information is a Gaussian distribution map, and inputting the to-be-denoised image and the a priori knowledge information into the target denoising model includes: the to-be-denoised image and the Gaussian distribution map are input into the target denoising model to obtain the target image output by the target denoising model after removing the Gaussian noise.

In this embodiment, if the Gaussian noise in the image is to be removed, the to-be-denoised image and the Gaussian distribution map can be input to the model for removing the Gaussian noise. In this way, the target image output by the model after the Gaussian noise is removed can be obtained.

In an embodiment, the to-be-denoised image is a magnetic resonance image. The magnetic resonance image is obtained by performing combining process on multi-channel data through a parallel imaging algorithm, and the multi-channel data is collected by magnetic resonance coils. The noise of the to-be-denoised image includes at least one of the following: first noise generated during the combining process, second noise caused by non-uniformity of the magnetic resonance coils, and Gaussian noise generated by a magnetic resonance device.

In this embodiment, if a certain type of noise in the image is to be removed, only the to-be-denoised image and the a priori knowledge information corresponding to the type of noise are input into a target denoising model for removing the type of noise, so as to obtain a target image output by such model with the type of noise removed. In this way, a certain type of noise can be removed in a targeted manner according to actual needs, which improves the flexibility of denoising.

A complete embodiment for removing the above three types of noise is described below. In practical applications, the order of removing different types of noise can be determined according to actual needs. For example, the second noise can be removed first, then the first noise can be removed, and the Gaussian noise can be removed finally; or the first noise can be removed first, then the second noise is removed, fmally the Gaussian noise is removed, etc., which is not specifically limited in the present disclosure.

In the present disclosure, an example is described in which the first noise is removed, then the second noise is removed, and the Gaussian noise is removed finally.

First, the noise in the to-be-denoised image includes the first noise. Inputting the to-be-denoised image and the a priori knowledge information into the target denoising model to obtain the denoised target image output by the target denoising model may further include: inputting the multi-channel data, the to-be-denoised image and the a priori knowledge information to the target denoising model for removing the first noise in a magnetic resonance image to obtain a first target image output by the target denoising model after the first noise is removed.

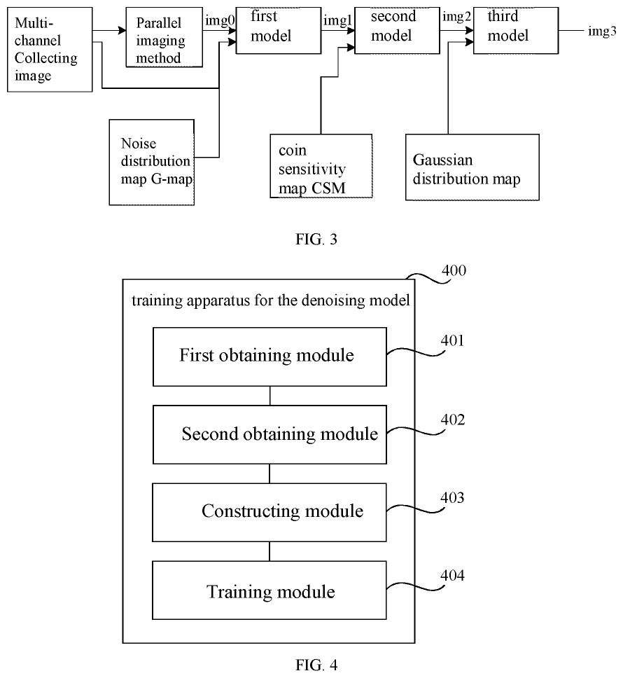

FIG. 3 is a flowchart illustrating an example image denoising method. As shown in FIG. 3, the multi-channel data collected by the magnetic resonance coils is first obtained, and parallel imaging is performed on the multi-channel data to obtain a combined magnetic resonance image img0. The magnetic resonance image img0 is used as the to-be-denoised image, and the to-be-denoised image includes the first noise. Then the multi-channel data collected by the magnetic resonance coils, the magnetic resonance image img0 and a priori knowledge information corresponding to the first noise (e.g., a G-Map) are input to the target denoising model for removing the first noise in the magnetic resonance image (e.g., the first module), and a magnetic resonance image imgl (e.g., the first target image) output by the first model is obtained.

Since the multi-channel data is real data collected by the magnetic resonance coils, when the first noise is removed, the multi-channel data is also input to the first model to ensure that the first target image with the first noise removed is not distorted.

The noise in the to-be-denoised image also includes the second noise. After a priori knowledge information corresponding to the second noise is obtained, the first target image and the a priori knowledge information corresponding to the second noise are input to a target denoising model for removing the second noise to obtain a second target image output by the target denoising model after the second noise is removed.

As shown in FIG. 3, the magnetic resonance image imgl and the a priori knowledge information corresponding to the second noise (e.g., a CSM) are input to the target denoising model for removing the second noise (e.g., the second model) to obtain a magnetic resonance image img2 (e.g., the second target image) output by the second model after the second noise is removed.

Finally, after a priori knowledge information corresponding to the Gaussian noise is obtained, the second target image and the a priori knowledge information corresponding to the Gaussian noise are input into a target denoising model for removing the Gaussian noise to obtain a third target image output by the target denoising model after the Gaussian noise is removed.

As shown in FIG. 3, the magnetic resonance image img2 and the a priori knowledge information corresponding to the Gaussian noise (e.g., a Gaussian distribution map) are input to the target denoising model for removing the Gaussian noise (e.g., the third model) to obtain a third magnetic resonance image img3 (e.g., the third target image) output by the model after the Gaussian noise is removed. The magnetic resonance image img3 is an image obtained by sequentially removing the first noise, the second noise, and the Gaussian noise from the magnetic resonance image img0. The magnetic resonance image img3 is the denoised target image.

By using the above technical solutions, the mixed noise in the image is decomposed into different noise sources for removal, which can not only remove the noise from noise sources, but also improve the interpretability of each denoising process. When removing noise corresponding to each noise source, the a priori knowledge information corresponding to the noise is taken into consideration, which improves the accuracy of denoising.

In some examples, a training device for the denoising model is provided. FIG. 4 is a block diagram illustrating an example training apparatus for a denoising model according. As shown in FIG. 4, the training apparatus 400 for the denoising model includes: a first obtaining module 401, configured to obtain a plurality of to-be-denoised sample images; a second obtaining module 402, configured to, for each of the to-be-denoised sample images, obtain a priori knowledge information corresponding to noise in the to-be-denoised sample image; a constructing module 403, configured to, for each of the to-be-denoised sample images, construct a model training sample based on the to-be-denoised sample image and a priori knowledge information; anda training module 404, configured to train a denoising model based on a plurality of model training samples to obtain a target denoising model for removing noise in an image.

In some examples, the second obtaining module 402 is configured to obtain a Gaussian noise distribution map of the to-be-denoised sample image as the a priori knowledge information.

In some examples, the first obtaining module 401 is configured to, for each of the to-be-denoised sample images, obtain multi-channel sample data collected by magnetic resonance coils; perform a merging process on the multi-channel sample data through a parallel imaging algorithm, to obtain a magnetic resonance image as the to-be-denoised sample image; wherein the noise of the to-be-denoised sample image includes at least one of the following: a first noise generated during the merging process, a second noise caused by an unevenness of the magnetic resonance coils, and a Gaussian noise generated by a magnetic resonance device.

In some examples, the noise in the to-be-denoised image is the first noise, and the constructing module 403 is configured to construct a model training sample based on the multi-channel sample data, the to-be-denoised sample image and the a priori knowledge information corresponding to the first noise.

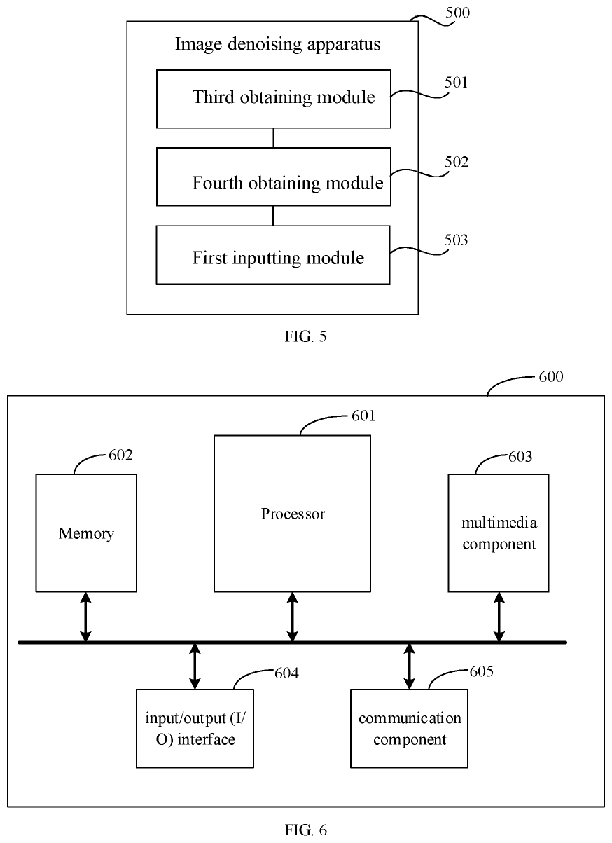

FIG. 5 is a block diagram illustrating an example image denoising apparatus. As shown in FIG. 5, the image denoising apparatus 500 includes:

a third obtaining module 501, configured to obtain a to-be-denoised image;

a fourth obtaining module 502, configured to obtain a priori knowledge information corresponding to noise in the to-be-denoised image;

a first inputting module 503, configured to input the to-be-denoised image and the a priori knowledge information into a trained target denoising model, to obtain a denoised target image output by the target denoising model, wherein the target denoising model is trained by: obtaining a plurality of to-be-denoised sample images; for each of the to-be-denoised sample images, obtaining a priori knowledge information corresponding to noise in the to-be-denoised sample image; for each of the to-be-denoised sample images, constructing a model training sample based on the to-be-denoised sample image and the a priori knowledge information; training a denoising model based on a plurality of model training samples to obtain a target denoising model for removing noise in image.

In some examples, the target denoising model is a model for removing Gaussian noise, and the a priori knowledge information is a Gaussian distribution map, the first inputting module 503 is configured to input the to-be-denoised image and the Gaussian distribution map into the target denoising model to obtain the target image output by the target denoising model after removing the Gaussian noise.

In some examples, the noise in the to-be-denoised image is the first noise, the first inputting module 503 is configured to input the multi-channel data, the to-be-denoised image and the a priori knowledge information into a sub-target denoising model for removing the first noise in the magnetic resonance to obtain a first target image output by the sub-target denoising model after removing the first noise.

In some examples, the to-be-denoised image further includes the second noise and the Gaussian noise, the apparatus further includes:

a fifth obtaining module, configured to obtain a priori knowledge information corresponding to the second noise;

a second inputting module, configured to input the first target image and the a priori knowledge information corresponding to the second noise into a sub-target denoising model for removing the second noise to obtain a second target image output by the sub-target denoising model after removing the second noise;

a sixth obtaining module, configured to obtain a priori information corresponding to the Gaussian noise;

a third inputting module, configured to input the second target image and the a priori information corresponding to the Gaussian noise into a sub-target denoising model for removing the Gaussian noise to obtain a third target image output by the sub-target denoising model after removing the Gaussian noise; wherein the third target image is an image obtained by sequentially removing the first noise, the second noise and the Gaussian noise from the magnetic resonance image.

Regarding the apparatuses in the above examples, the specific manner in which each module performs operations has been described in detail in the examples of the methods, and will not be described in detail here.

FIG. 6 is a schematic structural diagram illustrating an example electronic device 600. As shown in FIG.6, the electronic device 600 may include: a processor 601, and a memory 602. The electronic device 600 may further include one or more of a multimedia component 603, an input/output (I/O) interface 604, and a communication component 605.

The processor 601 is used to control the overall operation of the electronic device 600 to complete all or part of the steps in the training method of the denoising model described above. The memory 602 is used to store various types of data to support operations on the electronic device 600. These data may include, for example, instructions for any application or method to operate on the electronic device 600, as well as application-related data. For example, contact data, sent and received messages, pictures, audio, video, etc. The memory 602 can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read only memory (ROM), magnetic memory, flash memory, magnetic disk or optical disk. The multimedia component 603 may include a screen and an audio component. The screen may be a touch screen, for example, and the audio component is used to output and/or input audio signals. For example, the audio component may include a microphone, which is used to receive external audio signals. The received audio signal may be further stored in the memory 602 or sent via the communication component 605. The audio component also includes a speaker for outputting an audio signal. The I/O interface 604 provides an interface between the processor 601 and other interface module. The other interface module may be a keyboard, click wheel, a button other the like. The button can be a virtual button or a physical button. The communication component 605 is configured to facilitate performed wired or wireless communication between the electronic device 600 and other devices. Wireless communication, such as Wi-Fi, Bluetooth, near field communication (NFC), 2G, 3G, 4G, NB-IOT, eMTC, or other 5G, etc., or a combination of one or more of above is not limited here. Therefore, the corresponding communication component 605 may include: a Wi-Fi module, a Bluetooth module, an NFC module, and so on.

In an example embodiment, the electronic device 600 may be implemented by one or more application specific integrated circuits (ASIC), digital signal processor (DSP), or digital signal processing device (DSPD), programmable logic device (PLD), field programmable gate array (FPGA), controller, microcontroller, microprocessor or other electronic components, and used to perform the above-mentioned training method of the denoising model.

In an example embodiment, there is further provided a computer-readable storage medium having program instructions, which can be executed by a processor to implement the steps of the training method of the denoising model. For example, the computer-readable storage medium may be the memory 602 including program instructions, and the program instructions may be executed by the processor 601 of the electronic device 600 to implement the training method of the denoising model.

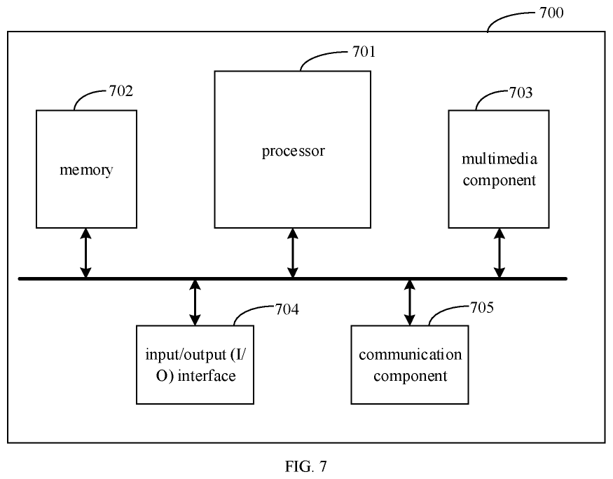

FIG. 7 is a schematic structural diagram illustrating an electronic device 700 according to an example of the present disclosure. As shown in FIG.6, the electronic device 700 may include: a processor 701, a memory 702. The electronic device 700 may further include one or more of a multimedia component 703, an input/output (I/O) interface 704, and a communication component 705.

The processor 701 is used to control the overall operation of the electronic device 700 to complete all or part of the steps in the image denoising method described above. The memory 702 is used to store various types of data to support operations on the electronic device 700. These data may include, for example, instructions for any application or method to operate on the electronic device 700, as well as application-related data. For example, contact data, sent and received messages, pictures, audio, video, etc. The memory 702 can be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read only memory (ROM), magnetic memory, flash memory, magnetic disk or optical disk. The multimedia component 703 may include a screen and an audio component. The screen may be a touch screen, for example, and the audio component is used to output and/or input audio signals. For example, the audio component may include a microphone, which is used to receive external audio signals. The received audio signal may be further stored in the memory 702 or sent via the communication component 705. The audio component also includes a speaker for outputting an audio signal. The I/O interface 704 provides an interface between the processor 701 and other interface module. The other interface module may be a keyboard, click wheel, a button other the like. The button can be a virtual button or a physical button. The communication component 705 is configured to facilitate performed wired or wireless communication between the electronic device 700 and other devices. Wireless communication, such as Wi-Fi, Bluetooth, near field communication (NFC), 2G, 3G, 4G, NB-IOT, eMTC, or other 5G, etc., or a combination of one or more of above is not limited here. Therefore, the corresponding communication component 705 may include: a Wi-Fi module, a Bluetooth module, an NFC module, and so on.

In an example embodiment, the electronic device 700 may be implemented by one or more application specific integrated circuits (ASIC), digital signal processor (DSP), or digital signal processing device (DSPD), programmable logic device (PLD), field programmable gate array (FPGA), controller, microcontroller, microprocessor or other electronic components, and used to perform the above-mentioned training method of the denoising model.

In an example embodiment, there is further provided a computer-readable storage medium having program instructions, which can be executed by a processor to implement the steps of the image denoising method. For example, the computer-readable storage medium may be the memory 702 including program instructions, and the program instructions may be executed by the processor 701 of the electronic device 700 to implement the image denoising method.

In an example embodiment, a computer program product is also provided. The computer program product includes a computer program that can be executed by a programmable device, when the computer program is executed by the programmable device, a code part of the image denoising method is run.

Embodiments of the present disclosure are described in detail above with reference to the accompanying drawings. However, the present disclosure is not limited to the specific details in the above-mentioned embodiments. Within the scope of the technical concept of the present disclosure, various simple modifications can be made to the technical solutions of the present disclosure. These simple modifications all belong to the protection scope of the present disclosure.

Various specific technical features described in the foregoing specific embodiments can be combined in any suitable manner, provided that there is no contradiction. In order to avoid unnecessary repetition, various possible combinations are not described separately in the present disclosure.

Various different embodiments of the present disclosure can also be combined arbitrarily, as long as they do not violate the idea of the present disclosure, they should also be regarded as the content disclosed in the present disclosure.

For simplicity and illustrative purposes, the present disclosure is described by referring mainly to examples thereof. In the above descriptions, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

The above description is merely examples of the present disclosure and is not intended to limit the present disclosure in any form. Although the present disclosure is disclosed by the above examples, the examples are not intended to limit the present disclosure. Those skilled in the art, without departing from the scope of the technical scheme of the present disclosure, may make a plurality of changes and modifications of the technical scheme of the present disclosure by the method and technical content disclosed above.

Therefore, without departing from the scope of the technical scheme of the present disclosure, based on technical essences of the present disclosure, any simple alterations, equal changes and modifications should fall within the protection scope of the technical scheme of the present disclosure. Accordingly, other embodiments are within the scope of the following claims.

1. A training method for training a denoising model, comprising
obtaining a plurality of to-be-denoised sample images;
for each of the to-be-denoised sample images, obtaining a priori knowledge information corresponding to noise in the to-be-denoised sample image;
for each of the to-be-denoised sample images, constructing a model training sample based on the to-be-denoised sample image and the a priori knowledge information; and
training a denoising model based on the model training samples to obtain a target denoising model for removing noise in an image.

2. The training method of claim 1, wherein the noise comprises Gaussian noise, and obtaining the a priori knowledge information corresponding to the noise in the to-be-denoised sample image comprises:
obtaining a Gaussian noise distribution map of the to-be-denoised sample image as the a priori knowledge information.

3. The training method of claim 1, wherein each to-be-denoised sample image comprises M types of noise, and the denoising model comprises M sub-models connected in sequence, and M is an integer greater than or equal to 2;
wherein an input of a first sub-model in the M sub-models connected in sequence is a first model training sub-sample, an input of an N-th sub-model is an N-th model training sub-sample, wherein
a value range of N is 2 to M,
the first model training sub-sample at least comprises a to-be-denoised sample image and a priori knowledge information corresponding to a first type of noise in the M types of noise, and
the N-th model training sub-sample at least comprises an image output by an (N−1)-th sub-model and a priori knowledge information corresponding to an N-th type of noise in the M types of noise.

4. The training method of claim 1, wherein obtaining the plurality of to-be-denoised sample images comprises:
for each of the to-be-denoised sample images,
obtaining multi-channel sample data collected by magnetic resonance coils; and
performing a combining process on the multi-channel sample data through parallel imaging, to obtain a magnetic resonance image as the to-be-denoised sample image;
wherein the noise in the to-be-denoised sample image comprises at least one of the following: first noise generated during the combining process, second noise caused by non-uniformity of the magnetic resonance coils, or Gaussian noise generated by a magnetic resonance device.

5. The method of claim 4, wherein for at least one of the to-be-denoised sample images, the noise in the to-be-denoised image comprises the first noise, and constructing the model training sample based on the to-be-denoised sample image and the a priori knowledge information comprises:
constructing the model training sample based on the multi-channel sample data, the to-be-denoised sample image and a priori knowledge information corresponding to the first noise.

6. The training method of claim 4, wherein for at least one of the to-be-denoised sample images, the noise in the to-be-denoised sample image comprises the second noise, and the a priori knowledge information corresponding to the second noise comprises a coil sensitivity information distribution map.

7. The training method of claim 4, wherein for at least one of the to-be-denoised sample images, the noise in the to-be-denoised sample image comprises the Gaussian noise, and the a priori knowledge information corresponding to the Gaussian noise comprises a Gaussian distribution map.

8. An image denoising method, comprising:
obtaining a to-be-denoised image;
obtaining a priori knowledge information corresponding to noise in the to-be-denoised image; and
inputting the to-be-denoised image and the a priori knowledge information into a trained target denoising model, to obtain a denoised target image output by the target denoising model, wherein the target denoising model is trained by the training method of claim 1.

9. The method of claim 8, wherein the target denoising model is a model for removing Gaussian noise, and the a priori knowledge information is a Gaussian distribution map, and inputting the to-be-denoised image and the a priori knowledge information into the trained target denoising model comprises:
inputting the to-be-denoised image and the Gaussian distribution map into the target denoising model to obtain the denoised target image output by the target denoising model after removing the Gaussian noise.

10. The method of claim 8, wherein the to-be-denoised image comprises M types of noise, and the target denoising model comprises M sub-target denoising models connected in sequence, and M is an integer greater than or equal to 2;
wherein an input of a first sub-target denoising model in the M sub-target denoising models connected in sequence is the to-be-denoised image and a priori knowledge information corresponding to a first type of noise in a denoising order for the to-be-denoised image, an input of an N-th sub-target denoising model is an image output by an (N−1)-th sub-target denoising model and a priori knowledge information corresponding to an N-th type of noise in the denoising order, wherein a value range of N is 2 to M.

11. The method of claim 8, wherein the to-be-denoised image is a magnetic resonance image, the magnetic resonance image is obtained by performing a combing process on multi-channel data through parallel imaging, the multi-channel data having been collected by magnetic resonance coils, and the noise of the to-be-denoised image comprises at least one of the following:
first noise generated during the combining process,
second noise caused by non-uniformity of the magnetic resonance coils, or
Gaussian noise generated by a magnetic resonance device.

12. The method of claim 11, wherein the noise in the to-be-denoised image comprises the first noise, and inputting the to-be-denoised image and the a priori knowledge information into the trained target denoising model to obtain the denoised target image output by the target denoising model comprises:
inputting the multi-channel data, the to-be-denoised image and the a priori knowledge information into a first sub-target denoising model for removing the first noise in the magnetic resonance image to obtain a first target image output by the first sub-target denoising model after removing the first noise.

13. The method of claim 12, wherein the noise of the to-be-denoised image comprises the first noise, the second noise and the Gaussian noise, and wherein the method further comprises:
obtaining a priori knowledge information corresponding to the second noise;
inputting the first target image and the a priori knowledge information corresponding to the second noise into a second sub-target denoising model for removing the second noise to obtain a second target image output by the second sub-target denoising model after removing the second noise;
obtaining a priori knowledge information corresponding to the Gaussian noise; and
inputting the second target image and the a priori knowledge information corresponding to the Gaussian noise into a third sub-target denoising model for removing the Gaussian noise to obtain a third target image output by the third sub-target denoising model after removing the Gaussian noise, wherein the third target image is an image obtained by sequentially removing the first noise, the second noise and the Gaussian noise from the magnetic resonance image.

14. A non-transitory computer readable storage medium storing a computer program, wherein the program is executed by one or more processors to perform the method according to claim 1.

15. A non-transitory computer readable storage medium storing a computer program, wherein the program is executed by one or more processors to perform the method according to claim 8.

16. An electronic device, comprising:
a memory storing a computer program;
one or more processors configured to execute the computer program in the memory to implement the following:
obtaining a plurality of to-be-denoised sample images;
for each of the to-be-denoised sample images, obtaining a priori knowledge information corresponding to noise in the to-be-denoised sample image;
for each of the to-be-denoised sample images, constructing a model training sample based on the to-be-denoised sample image and the a priori knowledge information; and
training a denoising model based on a plurality of model training samples to obtain a target denoising model for removing noise in an image.

17. An electronic device, comprising:
a memory storing a computer program; and
one or more processors configured to execute the computer program in the memory to implement the method of claim 8.
